(19) United States
(12) Patent Application Publication
(10) Pub. No.: US 2008/0261132 A1
(43) Pub. Date: Oct. 23, 2008

(54) Resin for electrostatic-image-developing toner, electrostatic-image-developing toner, electrostatic image developer, method for forming image, and image-forming apparatus

(75) Inventors: Hideo Maehata, Kanagawa (JP); Hirotaka Matsuoka, Kanagawa (JP); Yasuo Matsumura, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 12/071,777

(22) Filed: Feb. 26, 2008

(30) Foreign Application Priority Data
Apr. 20, 2007 (JP) 2007-111188

(51) Int. Cl. G03G 9/08; G03G 13/04; G03G 15/00

(52) U.S. Cl. 430/48; 430/109.3; 399/159

(57) ABSTRACT

A resin for an electrostatic-image-developing toner includes a polyester resin; a vinyl polymer resin obtained by polymerization of a radically polymerizable vinyl monomer; and at least one of a nitroxide compound and a reaction product of a nitroxide compound and an acid.

### CROSS-REFERENCE TO RELATED APPLICATIONS

This application is based on and claims priority under 35 USC 119 from Japanese Patent Application No. 2007-111188 filed on Apr. 20, 2007.

### BACKGROUND

1. Technical Field

The present invention relates to a resin for an electrostatic-image-developing toner, an electrostatic-image-developing toner, an electrostatic image developer, an image-forming method, and an image-forming apparatus.

2. Related Art

In recent years, in the toner for electrophotography, in addition to conventional requirements for higher image quality and higher productivity, further energy saving manufacture of toners has been required from the viewpoint of the reduction of environmental load.

For satisfying these requirements for the toner for electrophotography, the manufacturing method of the toner has been shifting from conventional methods of melting and kneading resins at a high temperature of 100° C. or more and then grinding and classifying to the what is called chemical manufacturing method, such as an emulsification polymerization flocculation method and a suspension polymerization method of manufacturing a toner at a temperature of 100° C. or less and, further, capable of more precisely controlling powder characteristics of the toner such as the grain size and structure of the toner as compared with the kneading and grinding methods.

In these toners by chemical manufacturing methods, a vinyl polymer that is a polymer of a radically polymerizable vinyl monomer has been used as the resin component. However, in the requirement for further higher image quality and a low energy electrophotographic system in the market, conversion of toner resin components from conventional vinyl polymers to various kinds of polycondensation resins including polyester resins, and use of blended resins of these polycondensation resins with vinyl polymers have been examined.

In the manufacture of the toners by chemical manufacturing methods, processes of dispersion and emulsification of toner resins in an aqueous medium are essential. In the use of radically polymerizable vinyl polymers in the present situation, a dispersion of resin grains in an aqueous medium can be industrially easily manufactured by emulsion polymerization and suspension polymerization methods. While in the case of polycondensation resins such as polyester, it is difficult to use these techniques as principle. Therefore, resins are emulsified and dispersed in an aqueous medium by a high shearing force mechanical dispersing method that necessitates a vast quantity of energy with a great amount of dispersants after once resins are polymerized by block polymerization or solution polymerization, or by a phase inversion emulsification method of phase inverting the resins with an organic solvent, and further finally removing the organic solvent. These methods of course become large problems from the viewpoints of the characteristics of the toner in the manufacture and environmental load.

### SUMMARY

According to an aspect of the invention, there is provided a resin for an electrostatic-image-developing toner including: a polyester resin; a vinyl polymer resin obtained by polymerization of a radically polymerizable vinyl monomer; and at least one of a nitroxide compound and a reaction product of a nitroxide compound and an acid.

### DETAILED DESCRIPTION

### (Resin for an Electrostatic-Image-Developing Toner)

The resin for an electrostatic-image-developing toner (hereinafter “electrostatic-image-developing toner” is sometimes also referred to as merely “toner”) according to an aspect of the invention contains a vinyl polymer resin obtained by polymerization of a polyester resin and a radically polymerizable vinyl monomer (hereinafter “radically polymerizable vinyl monomer” is sometimes also referred to as merely “vinyl monomer”), and at least one of a nitroxide compound and a reaction product of a nitroxide compound and an acid (hereinafter “a reaction product of a nitroxide compound and an acid” is sometimes also referred to as merely “a nitroxide reaction product”).

As the manufacturing method of the resin for an electrostatic-image-developing toner according to an aspect of the invention, the following method may be used. That is, blending by heating at least the radically polymerizable vinyl monomer, the nitroxide compound and the polyester resin to obtain a mixture (a blending process), emulsifying and dispersing the mixture in an aqueous medium (an emulsion polymerization process), and polymerizing the radically polymerizable monomer (a polymerization process) may be contained. Further, before or during the polymerization process, addition of an acid in an aqueous medium (an acid addition process) may be contained.

The resin for an electrostatic-image-developing toner according to an aspect of the invention is used as the binder resin for the electrostatic-image-developing toner.

The resin for an electrostatic-image-developing toner in the invention contains a vinyl polymer resin that is a radical polymer of polycondensation resin such as polyester and a vinyl monomer as the resin constituent. Further, the vinyl polymer contained in the resin may be a vinyl polymer resin polymerized in the presence of at least one of a nitroxide compound and a reaction product of a nitroxide compound and an acid (a nitroxide reaction product).

As described above, in the compatibility of image quality characteristics and fixing property of toners, a blend of a polyester resin and a vinyl polymer has been conventionally examined, but the trade off of image quality characteristics and fixing property of polyester with vinyl polymer is inevitable, so that the object cannot be sufficiently realized practicably. As a result of diligent examinations, it has been found that sufficient characteristics as toners can be achieved without being accompanied by the above trade off by using a vinyl polymer resin obtained by polymerization of a vinyl polymer in the presence of at least one of a nitroxide compound and a nitroxide reaction product, which has led to the present invention.

Concerning the polymerization of a vinyl polymer resin in the presence of a nitroxide compound is now under examination from the scientific and industrial points of view (for example, refer to Fischer, H., Macromolecules, 30, 5666 (1997), Fischer, H., Chem. Rev., 101, 3581 (2001), and Souaille, M., Macromolecules, 35, 248 (2002)).

There are reported in the above literatures that, as a structural characteristic, a nitroxide compound forms a polymer structure having nitroxide added to the molecular terminal during polymerization, that a nitroxide compound is accompanied by the formation of hydroxylamine of a derivative during polymerization, and dynamic characteristics such as the influences on the polymerization rate of these factors, uniformity of molecular weight distribution, etc.

However, many points are still unclear, such as the form of polymerization and influences on the characteristics of polymers. In the polymerization of a radically polymerizable vinyl monomer in the presence of a nitroxide compound in the invention too, this is presumably the effect by the fact that the structure of these terminal groups and the hydroxylamine coming into existence achieved compatibility and mixing ability that are unprecedented in connection with the interaction of the polyester resin and the vinyl polymer.

It has been found in the manufacturing method of the toner according to an aspect of the invention that it is possible to manufacture a toner for electrophotography having excellent image quality and fixing property without applying heavy environmental load by emulsifying or dispersing a mixture obtained by heating and dissolving a vinyl monomer, a polyester resin and a nitroxide compound in an aqueous medium, and then polymerizing the vinyl monomer.

In a conventional method of dissolving a polyester resin in a vinyl monomer, i.e., a method of using a vinyl monomer as an organic solvent initially, and performing radical polymerization after emulsification by relatively low energy, it can be expected to be capable of reducing exhaust emission by the reduction of a great quantity of emulsification energy such as mechanical shear, and by the cut down of extra processes such as a solvent-eliminating process. However, when a vinyl monomer is used in emulsification, if the temperature is not a relatively low temperature, emulsification is difficult due to self polymerizability by heating of the vinyl monomer. As a result, it is necessary to control the heating temperature at about 80° C. or lower. Accordingly, the addition of a great amount of vinyl monomer is necessary to obtain a good emulsified product.

On the other hand, when emulsification of a vinyl monomer is carried out in the presence of nitroxide as in the invention, self polymerizability by heating of the vinyl monomer can be irreversibly controlled by arbitrarily adjusting the amount of nitroxide. In the invention, the heating temperature of the vinyl monomer can be made higher, and a stable emulsified product can be easily manufactured even with a small amount of monomer.

### <Polyester Resins>

Polyester resins for use in the invention are manufactured by polycondensation reaction with a polyester-forming composition containing, as polycondensable monomers, polyvalent carboxylic acid (derivative) and polyhydric alcohol (derivative) as the raw material. Polycondensation catalysts may be used to accelerate polycondensation.

In the invention, the polyvalent carboxylic acids include aliphatic, alicyclic and aromatic polyvalent carboxylic acids, and alkyl esters, acid anhydrides, and acid chlorides of these polyvalent carboxylic acids, and the polyhydric alcohols include polyhydric alcohols, ester compounds of polyhydric alcohols and hydroxycarboxylic acids. Polyester resins can be manufactured by polycondensation by direct esterification reaction and ester exchange reaction using polycondensable monomers.

Polyvalent carboxylic acids for use in the invention are compounds having two or more carboxyl groups in one molecule. Of these compounds, divalent carboxylic acids are compounds having two carboxyl groups in one molecule, and, for example, oxalic acid, succinic acid, maleic acid, adipic acid, β-methyl-adipic acid, azelaic acid, sebacic acid, nonanedicarboxylic acid, decanedicarboxylic acid, undecanedicarboxylic acid, dodecenylsuccinic acid, dodecanedicarboxylic acid, fumaric acid, citraconic acid, diglycolic acid, cyclohexane-dicarboxylic acid, cyclohexane-3,5-diene-1,2-dicarboxylic acid, 2,2-dimethylolbutanoic acid, malic acid, citric acid, hexahydroterephthalic acid, malonic acid, pimelic acid, tartaric acid, mucic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediglycollic acid, p-phenylenediglycollic acid, o-phenylenediglycollic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, dodecenylsuccinic acid, etc., can be exemplified. As polyvalent carboxylic acids other than divalent carboxylic acids, e.g., trimellitic acid, pyromellitic acid, naphthalenetricarboxylic acid, naphthalenetetracarboxylic acid, pyrenetricarboxylic acid, pyrenetetracarboxylic acid, etc., can be exemplified.

These polyvalent carboxylic acids can be used by one kind alone, or two or more kinds may be used in combination.

Polyhydric alcohols (polyols) are compounds having two or more hydroxyl groups in one molecule. Of these compounds, dihydric polyol (diol) is a compound having two hydroxyl groups in one molecule and, for example, ethylene glycol, propylene glycol, butanediol, diethylene glycol, hexanediol, cyclohexanediol, octanediol, decanediol, dodecanediol, ethylene oxide adducts of bisphenol A, propylene oxide adducts of bisphenol A, bisphenoxy alcohol fluorene (bisphenoxy ethanol fluorene) etc., can be exemplified. As polyols other than dihydric polyols, e.g., glycerol, pentaerythritol, hexamethylolmelamine, hexaethylolmelamine, tetramethylol-benzoguanamine, tetraethylolbenzoguanamine, etc., can be exemplified.

These polyhydric alcohols (polyols) can be used by one kind alone, or two or more kinds may be used in combination.

Polyester structures can be arbitrarily controlled to a non-crystalline resin structure, a crystalline resin structure, or a mixed structure of these structures by the combination of these polycondensable monomers. In the invention, it is possible to use one or two or more kinds of polyester resins, and combinations of polyester structures such as non-crystalline and crystalline can be optionally selected.

In the invention, non-crystalline polyester resins are more preferably used as the polyester resins.

As polyvalent carboxylic acids to be used to obtain a crystalline polyester structure, oxalic acid, malonic acid, succinic acid, glutaric acid, adipic acid, pimelic acid, suberic acid, azelaic acid, sebacic acid, maleic acid, fumaric acid, citraconic acid, itaconic acid, glutaconic acid, n-dodecylsuccinic acid, n-dodecenylsuccinic acid, isododecylsuccinic acid, isododecenylsuccinic acid, n-octylsuccinic acid, n-octenylsuccinic acid, acid anhydrides of these acids, and acid chlorides of these acids are exemplified.

As polyhydric alcohol components, ethylene glycol, diethylene glycol, triethylene glycol, 1,2-propylene glycol, 1,3-propylene glycol, 1,4-butanediol, 1,4-butenediol, neopentyl glycol, 1,5-pentane glycol, 1,6-hexane glycol, 1,4-cyclohexanediol, 1,4-cyclohexanedimethanol, dipropylene glycol, polyethylene glycol, polypropylene glycol, etc., can be exemplified.

As the polyvalent carboxylic acids for use to obtain non-crystalline polyesters in the invention, of the above polyvalent carboxylic acids, as dicarboxylic acids, phthalic acid, isophthalic acid, terephthalic acid, tetrachloro-phthalic acid, chlorophthalic acid, nitrophthalic acid, malonic acid, mesaconic acid, p-carboxyphenylacetic acid, p-phenylenediacetic acid, m-phenylenediglycollic acid, p-phenylenediglycollic acid, o-phenylenediglycollic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, cyclohexanedicarboxylic acid, cyclohexenedicarboxylic acid, norbornene-2,3-dicarboxylic acid, adamantanedicarboxylic acid, and adamantanediacetic acid can be exemplified. Further, as polyvalent carboxylic acids other than dicarboxylic acids, e.g., trimellitic acid, pyromellitic acid, naphthalenetricarboxylic acid, naphthalenetetracarboxylic acid, pyrenetricarboxylic acid, and pyrenetetracarboxylic acid can be exemplified. The carboxyl groups of these carboxylic acids may be derived to acid anhydride, acid chloride or ester.

Of these carboxylic acids, terephthalic acids and lower esters thereof, diphenylacetic acids, and cyclohexane-dicarboxylic acids are preferably used. Incidentally, lower esters are esters of aliphatic alcohols having from 1 to 8 carbon atoms.

As the polyols for use to obtain non-crystalline polyesters in the invention, of the above polyols, polytetra-methylene glycol, bisphenol A, bisphenol Z, bisphenol S, biphenol, naphthalenediol, adamantanediol, adamantanedimethanol, hydrogenated bisphenol A, cyclohexanedimethanol, and bisphenoxy alcohol fluorene are preferably used.

For manufacturing one kind of polyester, the polyvalents carboxylic acid and polyols may be used respectively by one kind alone, or one side may be one kind and the other side may be two or more kinds, or both may be used respectively by twos or more kinds. When hydroxycarboxylic acids are used for manufacturing one kind of a polycondensable resin, they may be used by one kind alone, or two or more kinds may be used, or polyvalent carboxylic acids and polyols may be used in combination.

As the polyester resins for use in the toner according to an aspect of the invention, when the polyester resins are crystalline, the crystalline melting point Tm of the resins is preferably in the range of from 50 to 120° C., and more preferably from 55 to 90° C. When Tm is 50° C. or more, good flocculation force of the binder resins themselves can be obtained in a high temperature region, and a separating property is not deteriorated in fixation, and, further, offset does not occur. Further, when Tm is 120° C. or less, sufficient melting can be obtained and a preferred minimum fixing temperature can be ensured.

On the other hand, when the polyester resins are non-crystalline, the glass transition point Tg of the resins is preferably from 40 to 80° C., and more preferably from 50 to 65° C. When Tg is 40° C. or more, the flocculation force of the resins themselves in a high temperature region is retained and not accompanied by hot offset in fixation. Further, when Tg is 80° C. or less, sufficient melting can be obtained and a preferred minimum fixing temperature can be assured.

In the measurement of the melting point of a crystalline resin, a differential scanning calorimeter (DSC) is used. The melting point can be found as the melting peak temperature in the measurement of input compensation differential scanning calorimetry shown in JIS K-7121 in performing measurements from room temperature to 150° C. by a temperature rising rate of 10° C. per minute. There are cases where crystalline resins show a plurality of melting peaks, and the maximum peak is regarded as melting point in the invention.

The glass transition point of non-crystalline resins is a value obtained by measurement in conformity with the method provided in ASTM D3418-82 (a DSC method).

“Crystallizability” shown in the above “crystalline polyester resins” shows to have a clear endothermic peak not stepwise endothermic variation in differential scanning calorimetry (DSC), and specifically means that the half value width of the endothermic peak measured at a temperature rising rate of 10° C. per minute is not higher than 10° C.

On the other hand, resins having the half value width of endothermic peak exceeding 10° C. and resins not having a clear endothermic peak mean to be non-crystalline (amorphous).

Further, the weight average molecular weight of polyester resins to be used is preferably in the range of from about 1,500 to about 60,000, and more preferably from about 3,000 to about 40,000. When the weight average molecular weight is not lower than 1,500, preferred flocculation force can be obtained as the binder resin, and not accompanied by the reduction of hot offset property. While when the weight average molecular weight is not higher than 60,000, a good hot offset property and a preferred minimum fixing temperature can be obtained.

Resins may be partly branched or may have a crosslinking structure according to the selection of the number of carboxylic acid values of the monomers and the number of alcohol values.

In the invention, the acid value of the polyester resin to be obtained is preferably from about 3 mg KOH/g to about 50 mg KOH/g, and more preferably from about 5 mg KOH/g to about 40 mg KOH/g. When the acid value of the polyester resin is in the above range, good dispersibility of the resin grains can be obtained, and electrostatic charge characteristics of the electrostatic-image-developing toner using this polyester resin is heightened.

As polycondensation catalysts that can be used in the invention, known catalysts that are used in polymerization reaction of polyesters, for example, organic and inorganic metal catalysts containing metal elements such as titanium, antimony, tin and aluminum, sulfur acids, acids having surface activating effect, and hydrolytic enzyme type catalysts are exemplified. Of these catalysts, sulfur acids are preferably used.

By the use of sulfur acids, polycondensation is possible at a low polycondensation temperature, and the electrostatic-image-developing toner using the resins polycondensed with sulfur acids has a good electrostatic charging property.

The sulfur acids are oxygen acids of sulfur, and inorganic sulfur acids and organic sulfur acids are exemplified.

As the inorganic sulfur acids, sulfuric acid, sulfurous acid, and salts of these acids are exemplified. As the organic sulfur acids, sulfonic acids, e.g., alkylsulfonic acid, arylsulfonic acid, and salts of these acids, alkylsulfuric acid, arylsulfuric acid, and salts of these acids are exemplified.

As sulfur acids, organic sulfur acids are preferred, and organic sulfur acids having surface activating effect are more preferred. The acids having surface activating effect are compounds having a structure including a hydrophobic group and a hydrophilic group, having a structure of an acid in which at least a part of the hydrophilic group includes a proton, and having emulsifying function and catalytic function in combination.

As organic sulfur acids, e.g., alkylbenzenesulfonic acid, alkylsulfonic acid, alkyldisulfonic acid, alkylphenol-sulfonic acid, alkylnaphthalenesulfonic acid, alkyltetralin-sulfonic acid, alkylallylsulfonic acid, petroleum sulfonic acid, alkylbenzimidazolesulfonic acid, higher alcohol ether sulfonic acid, alkyldiphenylsulfonic acid, long chain alkylsulfate, higher alcohol sulfate, higher alcohol ether sulfate, higher fatty acid amide alkylolsulfate, higher fatty acid amide alkylated sulfate, sulfated fat, sulfosuccinate, alcohol sulfate resinate, and salt compounds of all of these acids are exemplified. If necessary, two or more of these acids may be used in combination. Specifically, dodecylbenzene-sulfonic acid, pentadecylbenzenesulfonic acid, isopropyl-benzenesulfonic acid, camphorsulfonic acid, p-toluene-sulfonic acid, monobutylphenylphenolsulfuric acid, dibutylphenylphenolsulfuric acid, dodecylsulfuric acid, naphthenyl alcohol sulfuric acid, etc., are exemplified. These sulfur acids may have any functional group in the structure.

As the organic sulfur acids having surface activating effect, of the above exemplified organic sulfur acids, organic sulfur acids having an alkyl group having from 7 to 20 carbon atoms, or having an aralkyl group having from 13 to 26 carbon atoms are exemplified, and dodecylbenzenesulfonic acid, pentadecylbenzenesulfonic acid, and dodecylsulfuric acid are preferred.

When sulfur acids are used in the invention, they may be used by one kind alone, or two or more kinds may be used in combination.

As the acids having surface activating effect, various kinds of fatty acids, sulfonated higher fatty acids, higher alkylphosphate, resin acids, naphthenic acid, and salt compounds of all of these acids are exemplified.

The following can be exemplified as the metal catalysts, but the invention is not restricted thereto. For example, organic tin compounds, organic halide compounds, and rare earth metal catalysts can be exemplified. As the metal catalysts containing rare earth metals, specifically the metal catalysts containing the following elements are useful, i.e., scandium (Sc), yttrium (Y), lanthanum (La) as lanthanoid element, cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), or lutetium (Lu), and especially the metal catalysts having alkylbenzenesulfonate, alkylsulfate, or triflate structure are useful. Of these, the metal catalysts having a triflate structure are preferred. As the structural formula of the triflate, X(OSO₂CF₃)₃ is exemplified, where X is a rare earth element, and scandium (Sc), yttrium (Y), ytterbium (Yb), and samarium (Sm) are preferred.

Lanthanoid triflate is described in detail, e.g., in Yuki Gosei Kagaku Kyokai-Shi (Bulletin of Organic Synthesis Chemistry Association), Vol 53, No. 5, pp. 44-54.

The hydrolytic enzyme type catalysts are not especially restricted so long as they catalyze ester synthesis reaction. As the hydrolytic enzymes that can be used in the invention, esterase classified into EC (enzyme code number) 3.1 group (refer to Maruo and Tamiya compiled, Koso Handbook (Enzyme Handbook), Asakura Publishing Co., Ltd. (1982)), e.g., carboxyl esterase, lipase, phospholipase, acetyl esterase, pectin esterase, cholesterol esterase, tannase, monoacyl glycerol lipase, lactonase, lipoprotein lipase, etc., hydrolytic enzymes classified into EC 3.2 group that act on glycosyl compounds, e.g., glucosidase, galactosidase, glucuronidase, xylosidase, etc., hydrolytic enzymes classified into EC 3.3 group, e.g., epoxide hydrase, etc., hydrolytic enzymes classified into EC 3.4 group that act on peptide bonds, e.g., aminopeptidase, chymotrypsin, trypsin, plasmin, subtilisin, etc., and hydrolytic enzymes classified into EC 3.7 group, e.g., phloretin, hydrase, etc., are exemplified.

Of the above esterases, enzymes that hydrolyze glycerol esters to separate fatty acids are especially called lipase. The lipases have high stability in organic solvents and catalyze ester synthesis reaction in high yield, and, further, available inexpensively. Accordingly, in view of the yield and costs, lipases are preferably used in the invention.

Lipases of various derivations can be used in the invention. As preferred lipases, lipases obtained from microorganisms such as Pseudomonas genus, Alcaligenes genus, Achromobacter genus, Candida genus, Aspergillus genus, Rhizopus genus, Mucor genus, etc., lipases obtained from seeds of plants, lipases obtained from animal tissues, and pancreatin and steapsin can be exemplified. Of these lipases, lipases obtained from microorganisms such as Pseudomonas genus, Candida genus, and Aspergillus genus are preferably used.

In the invention, polycondensation reaction can be carried out by bulk polymerization, polymerization in water, such as emulsion polymerization and suspension polymerization, solution polymerization, interfacial polymerization, and general polycondensation, and bulk polymerization is preferably used. Polycondensation reaction can be performed under atmospheric pressure, but for the purpose of achieving higher molecular weight of polyester resin, general conditions such as reaction under reduced pressure and nitrogen current can be widely used.

### <Radically Polymerizable Vinyl Monomer>

In the invention, radically polymerizable vinyl monomer means a monomer having a radically polymerizable unsaturated bond. That is, the radically polymerizable vinyl monomer is not restricted to compounds having a vinyl group, and compounds having an acryloxy group, a methacryloxy group, a styryl group, an acrylamido group, a methacrylamido group, a vinyl ether group, or an olefin bond are widely included.

As the radically polymerizable vinyl monomers, an aromatic vinyl monomer, a (meth)acrylate monomer, a vinyl ester monomer, a vinyl ether monomer, a monoolefin monomer, a diolefin monomer, a halogenated olefin monomer can be exemplified.

As the aromatic vinyl monomers, styrenes, e.g., styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, 3,4-dichlorostyrene, etc., and the derivatives thereof can be exemplified.

As the (meth)acrylate monomers, methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl β-hydroxyacrylate, propyl γ-aminoacrylate, stearyl methacrylate, dimethylaminoethyl methacrylate, diethylaminoethyl methacrylate, etc., can be exemplified.

As the vinyl ester monomers, vinyl acetate, vinyl propionate, vinyl benzoate, etc., can be exemplified. As the vinyl ether monomers, vinyl methyl ether, vinyl ethyl ether, vinyl isobutyl ether, vinyl phenyl ether, etc., can be exemplified. As the monoolefin monomers, ethylene, propylene, isobutylene, 1-butene, 1-pentene, 4-methyl-1-pentene, etc., can be exemplified.

As the diolefin monomers, butadiene, isoprene, chloroprene, etc., can be exemplified. As the halogenated olefin monomers, vinyl chloride, vinylidene chloride, vinyl bromide, etc., can be exemplified. However, the radically polymerizable vinyl monomers in the invention are not limited thereto. These monomers can be used alone, or two or more monomers may be used in combination. Polymerized products can be obtained by polymerization with arbitrary polymerization initiators such as peroxides, persulfides, or azo compounds ordinarily used in polymerization of these monomers.

Considering the application to the electrostatic-image-developing toner, it is preferred that styrene or styrene derivative is used as the main component of the vinyl monomer from the points of charging characteristics and image quality characteristics.

Here, “being the main component” means that the styrene and styrene derivative account for about 50 wt % or more of the entire vinyl monomers. The content of the styrene and styrene derivative is preferably about 55 wt % or more in the entire vinyl monomers, and more preferably about 60 wt % or more.

Further, the content of the styrene and styrene derivative is preferably about 95 wt % or less of the entire amount of the vinyl monomer, more preferably about 90 wt % or less, and still more preferably about 80 wt % or less.

When the content of the styrene and styrene derivative is 50 wt % or more, when used as a toner, good charging characteristics (charging quantity and charging rate) can be ensured. Further, when the content of the styrene and styrene derivative is 95 wt % or less, heat characteristics as the toner can be well controlled (a glass transition temperature), and good fixing property can be obtained.

In the invention, the vinyl monomer may contain a vinyl monomer having a hydrophilic group. As the hydrophilic groups, polar groups are exemplified, such as acidic polar groups, e.g., a carboxyl group, a sulfo group, a phosphonyl group, a formyl group, etc., basic polar groups, e.g., an amino group, etc., and neutral polar groups, e.g., an amido group, a hydroxyl group, an acyl group, etc., but the polar groups are not restricted thereto. Of these groups, acidic polar groups are preferably used for toners. By the presence of the radically polymerizable monomer having an acid group on the surfaces of resin grains in a specific range, flocculating property is given to the resin grains to make the resin grains a toner, further, sufficient charging characteristics can be given to the toner.

As preferably used acidic polar groups, a carboxyl group and a sulfo group are exemplified. As monomers having these acidic polar groups, e.g., an α,β-ethylene unsaturated compound having a carboxyl group and an α,β-ethylene unsaturated compound having a sulfo group can be exemplified. As the α,β-ethylene unsaturated compounds having a carboxyl group, e.g., acrylic acid, methacrylic acid, fumaric acid, maleic acid, itaconic acid, cinnamic acid, monomethyl maleate, monobutyl ester maleate, monooctyl ester maleate can be exemplified. As the α,β-ethylene unsaturated compound having a sulfo group, e.g., sulfonated ethylene, Na salt thereof, allylsulfosuccinic acid and octyl allylsulfosuccinate can be exemplified. The α,β-ethylene unsaturated compounds having a carboxyl group are preferably used. These monomers may be used by one kind alone, or two or more monomers may be used in combination.

### <Nitroxide Compound>

In the invention, the resin for an electrostatic-image-developing toner contains at least one of a nitroxide compound and a reaction product of a nitroxide compound and an acid (a nitroxide reaction product).

As the method for manufacturing the resin for an electrostatic-image-developing toner, a method including blending by heating at least the radically polymerizable vinyl monomer, the nitroxide compound and the polyester resin to obtain a mixture, emulsifying and dispersing the mixture in an aqueous medium, adding an acid to the aqueous medium, and polymerizing the radically polymerizable monomer can be exemplified. It is preferred for the resin for an electrostatic-image-developing toner to contain at least one of the nitroxide compound and the nitroxide reaction product.

That is, in the polymerization of the vinyl monomer, it is preferred to introduce the nitroxide compound into the vinyl monomer in advance. Further, it is more preferred that the nitroxide compound be converted to the nitroxide reaction product by being processed with an acid before or during polymerization.

The equilibrium reaction of the nitroxide compound is shown by the following equilibrium formula (A). The following formula (I) is called Activation State. The nitroxide radical added to the terminal of polymer (P) chain is dissociated to generate a free and stable nitroxide and an active polymer radical. Polymerization progresses by the chain reaction of the active polymer radical with various radically reactive monomers.

The following formula (II) is called Dormant State, which shows the state where the nitroxide radical causes bimolecular termination reaction with the grown active radical and temporarily inactivated. The nitroxide compound can reversibly control the radical polymerization of the vinyl monomer by the following chemical equilibrium.

At this time, the polymerization rate of the vinyl monomer can be arbitrarily controlled by the adjustment of the polymerization temperature, the concentration of the nitroxide compound present in the polymerization system, and the concentration of the initiator (active radical). Further, by the arbitrary addition of an acid to the following shown nitroxide compound, the concentration of nitroxide radical (I) can be lowered and the parallel can be shift in the left-hand side direction, by which the polymerization rate can be accelerated and the secondary structure of the polymer can be optionally controlled.

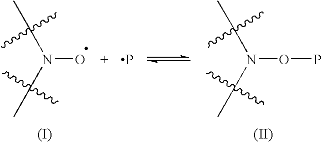

As the examples of the nitroxide compounds, the following can be exemplified. That is, PROXYL (2,2,5,5-tetramethyl-1-pyrrolidinyloxy) and derivatives thereof, e.g., 3-carboxyl-PROXYL, 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3-maleimido-PROXYL, 3,4-di-t-butyl-PROXYL, and 3-carboxylic-2,2,5,5-tetramethyl-1-pyrrolidinyloxy;

TEMPO (2,2,6,6-tetramethyl-1-piperidinyloxy) and derivatives thereof, e.g., 4-benzoxyloxy-TEMPO, 4-methoxy-TEMPO, 4-carboxylic-4-amino-TEMPO, 4-chloro-TEMPO, 4-hydroxylimine-TEMPO, 4-hydroxy-TEMPO, 4-oxo-TEMPO, 4-oxo-TEMPO-ethylene ketal, 4-amino-TEMPO, 2,2,6,6-tetraethyl-1-piperidinyloxy, and 2,2,6-trimethyl-6-ethyl-1-piperidinyl-oxy;

dialkyl nitroxide racical and derivatives thereof, e.g., di-t-butyl nitroxide, diphenyl nitroxide, and t-butyl-t-amyl nitroxide;

Further, DOXYL (4,4-dimethyl-1-oxazolidinyloxy) and derivatives thereof, e.g., 2-di-t-butyl-DOXYL, 5-decane-DOXYL, and 2-cyclohexane-DOXYL;

2,5-dimethyl-3,4-dicarboxylic-pyrrole, 2,5-dimethyl-3,4-diethyl ester-pyrrole, and 2,3,4,5-tetraphenyl-pyrrole;

In addition, 3-cyano-pyrroline, 3-carbamoylpyrroline, 3-carboxylic-pyrroline and derivatives thereof, e.g., 1,1,3,3-tetramethylisoindolin-2-yloxyl, and 1,1,3,3-tetraethylisoindolin-2-yloxyl; and

porphyrexide nitroxyl radical and derivatives thereof, e.g., 5-cyclohexyl porphyrexide nitroxyl, Galvinoxyl, 1,3,3-trimethyl-2-azabicyclo[2.2.2]octane-5-one-2-oxide, and 1-azabicyclo[3.3.1]nonane-2-oxide can be exemplified.

Adducts may be formed by the addition reaction of these nitroxide compounds and the vinyl monomers in advance.

The addition amount of the nitroxide compounds is preferably from 0.01 to 20 wt % based on all the amount of the vinyl monomer and polyester resin, more preferably from 0.1 to 15 wt %, and still more preferably from 0.5 to 10 wt %.

When the addition amount of the nitroxide compounds is in the above range, the manufacturing ability of the toner and the charging characteristics and fixing property of the toner are heightened.

Incidentally, at least one of the nitroxide compound and the nitroxide reaction product in the obtained resin for an electrostatic-image-developing toner can be detected and measured by the characteristic peak of the aliphatic chain of the nitroxide compound or alicyclic alkyl chain proton according to proton NMR.

Before and during polymerization of these vinyl monomers, various inorganic acids and organic acids may be added as additives. As the inorganic acids, hydrochloric acid, nitric acid and sulfuric acid, and as the organic acids, ascorbic acid and camphorsulfonic acid are exemplified. By the addition of at least one of the inorganic acid and the organic acid, polymerizability such as polymerization rate and polymerization structure can be arbitrarily adjusted.

The addition amount of the inorganic acid and the organic acid can be optionally selected in accordance with desired characteristics such as the dissociation rate of the nitroxide compound and the polymerization structure of the obtained polymer. The addition amount of the acids is preferably from 0.01 to 10 molar equivalent to the chemical equivalent of the added nitroxide compound, more preferably from 0.1 to 5 molar equivalent, and still more preferably from 0.1 to 1 molar equivalent.

When the addition amount of the acid is 0.01 molar equivalent or more of the nitroxide compound, polymerization rate becomes fast so that preferred from the manufacturing point of view, while when it is 10 molar equivalent or less, appropriate ion concentration of the product to be emulsified and sufficient emulsification stability can be obtained, so that preferred.

Of the above examples, as an exemplary embodiment, TEMPO (2,2,6,6-tetramethyl-1-piperidinyloxy) and its derivative 4-hydroxy-TEMPO, are preferably used as the nitroxide compound. Acids such as ascorbic acid and the like are preferably added thereto, by which hydroxylamine is formed and reaction rate and the uniformity of a polymer structure can be controlled.

Further, in the invention, the vinyl polymer resin obtained by polymerization of the radically polymerizable vinyl monomer preferably account for bout 5 wt % to about 50 wt % by weight ratio in all the resin components, and more preferably from about 9 wt % to about 30 wt %.

When the content of the vinyl polymer is 5 wt % or more, uniform emulsification is preferably achieved, while when the content is 50 wt % or less, phase separation from the polyester resin does not occur, and when used as the electrostatic-image-developing toner, good image quality characteristics and fixing property can be preferably obtained.

### (Electrostatic-Image-Developing Toner and Manufacturing Method of the Same)

The manufacturing method of the electrostatic-image-developing toner according to an aspect of the invention preferably includes flocculating resin grains in a dispersion containing at least a resin grain dispersion to make flocculated grains, and melting the flocculated grains by heating, wherein the resin grain dispersion contains the resin for an electrostatic-image-developing toner according to an aspect of the invention.

That is, the manufacturing method is what is called an emulsification polymerization flocculation method including flocculation and fusion of resin grains, which includes blending by heating at least a radically polymerizable vinyl monomer, a nitroxide compound and a polyester resin, emulsifying and dispersing the mixture in water, blending the dispersion of resin grain obtained by radical polymerization of the vinyl monomer, if necessary, with a colorant grain dispersion and a releaser grain dispersion, flocculating, heating and melting.

### (Manufacturing Method of Resin Grain Dispersion)

A manufacturing method of a resin grain dispersion is described in detail below.

As a manufacturing method of a resin grain dispersion preferably used in the invention, a method including adding a nitroxide compound to a vinyl monomer, melting and dissolving by heating the polyester resin, and emulsifying the dissolved resin in an aqueous medium by applying proper shear force can be exemplified.

In the invention, a nitroxide compound has been added to a vinyl monomer and self-polymerization is restrained even when the vinyl monomer is heated at a higher temperature than conventional heating temperature, so that the vinyl monomer can be blended with a polyester resin at a higher temperature. The heating temperature is preferably from 90 to 200° C., more preferably from 95 to 150° C., and still more preferably from 100 to 120° C. In the invention, by setting the heating temperature in the above range, melting and dissolution of a polyester resin and succeeding emulsification and dispersion are made possible with a smaller amount of vinyl monomer than the amount heretofore in use. By using the thus-obtained resin grain dispersion, an electrostatic-image-developing toner excellent in image quality characteristics and fixing property can be obtained.

In more detail, the nitroxide compound is added to the vinyl monomer, and after the polyester resin is melted and dissolved by heating at about 100° C., the resin can be emulsified in an aqueous medium by heating according to the application of proper shear force. In emulsification dispersion, it is also possible to perform neutralization with ammonia and various amines generally used in emulsification dispersion of polyester in water, and various kinds of anionic and nonionic surfactants can also be added. Further, what is called auxiliary stabilizers, e.g., hexadecane, cetyl alcohol and the like can be added to suppress an Ostwald ripening phenomenon of the vinyl monomer.

After the mixture of polyester resin, vinyl monomer and nitroxide compound is emulsified in an aqueous medium, by the addition of at least one of an organic acid and inorganic acid thereto en bloc, or during polymerization in parts, the polymerization rate and structure of the vinyl monomer can be controlled. In this case, the addition amount of the acid is, as described above, preferably from 0.5 to 10 molar equivalent to the chemical equivalent of the nitroxide compound added.

In connection with the polymerization of the vinyl monomer after emulsification and dispersion, it is possible to use the technique of what is called mini-emulsion or micro-emulsion using known radical polymerization initiators with no restriction. It is also possible to use in combination of two or more kinds of polymerization methods, for example, these methods with emulsion polymerization and suspension polymerization methods so far been used.

In the invention, it is preferred that the polyester resin is dissolved by heating in the vinyl monomer, to which the nitroxide compound has been added, and emulsification dispersed in an aqueous medium, and then a radical polymerization initiator is added to polymerize the vinyl monomer, whereby to obtain a resin grain dispersion.

As the polymerization methods of the vinyl monomer, known polymerization methods can be adopted such as a method of using a radical polymerization initiator, a self-polymerization method by heating, and a method of using ultraviolet irradiation. Of these methods, a method of using a radical polymerization initiator is preferably used. As the radical polymerization initiators to be used, there are oil-soluble and water-soluble initiators, and either initiator can be arbitrarily used considering decomposition temperature, i.e., activation temperature.

The examples of the radical polymerization initiators include, e.g., ammonium persulfate, potassium persulfate, sodium persulfate, 2,2′-azobis(2-methylpropionamido) dihydrochloride, t-butylperoxy-2-ethyl hexanoate, cumyl perpivalate, t-butyl peroxy laurate, benzoyl peroxide, laurbyl peroxide, octanoyl peroxide, di-t-butyl peroxide, t-butylcumyl peroxide, dicumyl peroxide, 2,2′-azobisiso-butyronitrile, 2,2′-azobis(2-methylbutyronitrile), 2,2′-azobis(2,4-dimethylvaleronitrile), 2,2′-azobis(4-methoxy-2,4-dimethylvaleronitrile), 1,1-bis(t-butylperoxy)-3,3,5-trimethylcyclohexane, 1,1-bis(t-butylperoxy)-cyclohexane, 1,4-bis(t-butylperoxycarbonyl)cyclohexane, 2,2-bis(t-butylperoxy)octane, n-butyl-4,4-bis(t-butyl-peroxy)valylate, 2,2-bis(t-butylperoxy)butane, 1,3-bis(t-butylperoxyisopropyl)benzene, 2,5-dimethyl-2,5-di-(t-butyl-peroxy)hexane, 2,5-dimethyl-2,5-di(t-butylperoxy)hexane, 2,5-dimethyl-2,5-di(benzoylperoxy)hexane, di-t-butyl-diperoxyisophthalate, 2,2-bis(4,4-di-t-butylperoxy-cyclohexyl)propane, di-t-butylperoxy a-methylsuccinate, di-t-butylperoxydimethyl glutarate, di-t-butylperoxy-hexahydroxy terephthalate, di-t-butylperoxy azelate, 2,5-dimethyl-2,5-di(t-butylperoxy)hexane, diethylene glycol-bis(t-butylperoxycarbonate), di-t-butylperoxy-trimethyl adipate, tris(t-butylperoxy)triazine, vinyl-tris-(t-butylperoxy)silane, 2,2′-azobis(2-methylpropionamidine-dihydrochloride), 2,2′-azobis[N-(2-carboxyethyl)-2-methylpropionamidine], and 4,4′-azobis(4-cyanovaleric acid).

In the invention, the dispersion medium of the grain dispersion of the resin for an electrostatic-image-developing toner is an aqueous medium.

As the aqueous media that can be used in the invention, water, e.g., distilled water, ion exchange water, etc., and mixtures of these waters with alcohols, e.g., ethanol, methanol, etc., are exemplified. Of these aqueous media, ethanol and water are preferred, and water such as distilled water and ion exchange water are especially preferred. These aqueous media can be used by one kind alone, or two or more media can be used in combination.

In the invention, cumulative volume average grain size D₅₀ᵥ of the resin grains in the resin grain dispersion obtained as described above is preferably from 30 to 500 nm, and more preferably from 50 to 400 nm. By bringing the cumulative volume average grain size into the above range, a toner having narrower grain size distribution can be manufactured.

The cumulative volume average grain size (a median diameter) can be measured with a dynamic light scattering meter (e.g., LA920, manufactured by Horiba, Ltd.).

### <Flocculation Process>

In the flocculating process, since the resin grains according to an aspect of the invention are prepared in an aqueous medium, they can be used as a resin grain dispersion as they are. By mixing the resin grain dispersion with a colorant grain dispersion and a releaser grain dispersion, according to necessity, and further adding a flocculating agent and causing hetero-flocculation of these grains, flocculated grains of a toner can be formed. Further, after formation of the first flocculated grains, a dispersion of polyester resin grains or other polymer grains may be added thereto to thereby form second shell layers on the surfaces of the first grains. In the above example, the colorant dispersion is prepared separately, but when a colorant is blended with resin grains in advance, a colorant dispersion is not necessary.

### <Melting Process>

The flocculated grains are heated in the melting process at a temperature of the glass transition point or higher or the melting point or higher of the polyester resin to be melted and coalesced and, if necessary, washed and dried, thereby a toner can be obtained.

As the toner forms, from an amorphous form to a spherical form are preferably used. As the flocculating agents, besides surfactants, inorganic salts and divalent or higher metal salts may be used. Metal salts are preferably used in view of the control of flocculation and in characteristics such as charging of toners.

The constituents of the toner to be used are described below.

As the coloring components, carbon blacks, e.g., furnace black, channel black, acetylene black, thermal black, etc., inorganic pigments, e.g., red iron oxide, Prussian Blue, titanium oxide, etc., azo pigments, e.g., Fast Yellow, Disazo Yellow, Pyrazolone Red, chelate red, Brilliant Carmine, Para Brown, etc., phthalocyanine pigments, e.g., copper phthalocyanine, nonmetal phthalocyanine, etc., and condensed polycyclic pigments, e.g., flavanthrone yellow, dibromoanthrone orange, perylene red, quinacridone red, dioxazine violet, etc., are exemplified. Various kinds of pigments are exemplified, e.g., Chrome Yellow, Hansa Yellow, Benzidine Yellow, Indanthrene Yellow, Quinoline Yellow, Permanent Orange GTR, Pyrazolone Orange, Vulcan Orange, Watchung Red, Permanent Red, Dupont Oil Red, Lithol Red, Rhodamine B Lake, Lake Red C, Rose Bengal, Aniline Blue, Ultramarine Blue, Chalco Oil Blue, Methylene Blue Chloride, Phthalocyanine Blue, Phthalocyanine Green, Malachite Green Oxalate, C.I. Pigment Red 48:1, C.I. Pigment Red 122, C.I. Pigment Red 57:1, C.I. Pigment Yellow 12, C.I. Pigment Yellow 97, C.I. Pigment Yellow 17, C.I. Pigment Blue 15:1, C.I. and Pigment Blue 15:3, and these pigments can be used alone, or two or more kinds may be used in combination.

As the releasers, natural waxes, e.g., carnaubawax, rice wax, candelilla wax, etc., synthetic or mineral and petroleum waxes, e.g., low molecular weight polypropylene, low molecular weight polyethylene, sasol wax, microcrystalline wax, Fisher-Tropsch wax, paraffin wax, montan wax, etc., and ester waxes, e.g., fatty acid ester, montanate, etc., are exemplified, but the releasers are not restricted thereto. These releasers may be used by one kind alone, or two or more kinds may be used in combination. The melting point of the releasers is preferably 50° C. or higher in view of preservation, more preferably 60° C. or higher. From the viewpoint of offset resistance, the melting point is preferably 110° C. or lower, and more preferably 100° C. or lower.

When these releasers are dispersed in an aqueous medium with an ionic surfactant, and polymer electrolytes such as polymer acid and polymer base, heated at the melting point or higher, and atomized with a homogenizer capable of applying strong shearing, or a pressure disperser, a dispersion of grains having a grain size of 1 μm or less can be manufactured.

Besides the above, if necessary, various components, e.g., an internal additive, a charge controller, inorganic powder (inorganic grains), and organic grains can be added. As the examples of the internal additives, metals, such as ferrite, magnetite, reduced iron, cobalt, nickel, manganese, etc., alloys of these metals, and magnetic substances such as the compounds containing these metals are exemplified. As the charge controllers, quaternary ammonium salt compounds, Nigrosine compounds, dyes including complexes of aluminum, iron and chromium, and triphenylmethane pigments are exemplified. The inorganic powders are mainly added for the purpose of the adjustment of viscoelasticity of toners, and all the inorganic grains ordinarily used as the external additive of toners, e.g., silica, alumina, titania, calcium carbonate, magnesium carbonate, calcium phosphate, cerium oxide, etc., which are described in detail below, are exemplified.

The cumulative volume average grain size D₅₀ᵥ of the toner obtained by the manufacturing method of the electrostatic-image-developing toner according to an aspect of the invention is preferably from about 3.0 μm to about 9.0 μm, more preferably from about 3.0 μm to about 8.0 μm, and still more preferably from about 3.0 μm to about 7.0 μm. When D₅₀ᵥ is in the above range, strong adhesion and good developing properties can be obtained. Further, resolution of image is enhanced.

The volume average grain size distribution index GSDV of the obtained toner is preferably about 1.30 or less. When GSDV is 1.30 or less, good resolution is obtained, and image defects such as splashing of toners and fog are not caused.

A cumulative volume average grain size D₅₀ᵥ and a volume average grain size distribution index can be measured with measuring equipments, e.g., a Coulter Counter TAII (manufactured by Beckman Coulter K.K.) and Multisizer II (manufactured by Beckman Coulter K.K.). The cumulative distributions of volume and number of grains are drawn from the smaller grain side to the grain size range (channel) divided based on the grain size distribution, and the grain size of accumulation of 16% is defined as volume D₁₆ᵥ, number D₁₆ₚ, the grain size of accumulation of 50% is defined as volume D₅₀ᵥ, number D₅₀ₚ, and the grain size of accumulation of 84% is defined as volume D₈₄ᵥ, number D₈₄ₚ, respectively. By using these values, a volume average grain size distribution index (GSDᵥ) is computed as (D₈₄ᵥ/D₁₆ᵥ)^{1/2}, and a number average grain size distribution index (GSDₚ) is computed as (D₈₄ₚ/D₁₆ₚ)^{1/2}.

Shape factor SF1 of the obtained toner is preferably from about 100 to about 140 in the light of image forming property, and more preferably from about 110 to about 135. Shape factor SF1 can be found as follows. In the first place, the optical microscopic image of a toner sprayed on a slide glass is taken in LUZEX image analyzer via a video camera. SF1 is found as to toner grains of 50 or more and the obtained values are averaged. SF1 is defined as follows.

$$SF 1 = \frac{{( ML )}^{2}}{A} \times \frac{π}{4} \times 100$$

In the above expression, ML represents the absolute maximum length of a toner grain, and A is the projected area of a toner grain.

### (Electrostatic Image Developer)

The toner obtained by the manufacturing method of the electrostatic-image-developing toner according to an aspect of the invention described above is used as an electrostatic image developer. The developer is not especially restricted except for using the electrostatic-image-developing toner, and optional composition of component can be taken according to the intended use. When the electrostatic-image-developing toner is used alone, it is prepared as a one-component system electrostatic image developer, and when used in combination with a carrier, it is prepared as a two-component system electrostatic image developer.

### <Carrier>

The carrier is not especially restricted and those known as carriers themselves are exemplified. For example, known carriers such as resin covering carriers as disclosed in JP-A-62-39879 and JP-A-56-11461 can be used.

As the specific examples of carriers, the following resin covered carriers are exemplified. That is, as the nucleus grains of these carriers, nucleus grains formed of ordinary iron powder, ferrite, and magnetite are exemplified, and the average grain size is from 30 to 200 μm or so. As covering resins of the nucleus grains, styrenes, e.g., styrene, parachlorostyrene, α-methylstyrene, etc., α-methylene fatty acid monocarboxylic acids, e.g., methyl acrylate, ethyl acrylate, n-propyl acrylate, lauryl acrylate, 2-ethylhexyl acrylate, methyl methacrylate, n-propyl methacrylate, lauryl methacrylate, 2-ethylhexyl methacrylate, etc., nitrogen-containing acrylates, e.g., dimethylaminoethyl methacrylate, etc., vinylnitriles, e.g., acrylonitrile, methacrylonitrile, etc., vinylpyridines, e.g., 2-vinylpyridine, 4-vinylpyridine, etc., vinyl ethers, e.g., vinyl methyl ether, vinyl isobutyl ether, etc., vinyl ketones, e.g., vinyl methyl ketone, vinyl ethyl ketone, vinyl isopropenyl ketone, etc., polyolefins, e.g., ethylene, propylene, etc., silicones, e.g., methyl silicone, methylphenyl silicone, etc., copolymers of fluorine-containing vinyl monomers, e.g., vinylidene fluoride, tetrafluoroethylene, hexafluoroethylene, etc., polyesters containing bisphenol or glycol, epoxy resins, polyurethane resins, polyamide resins, cellulose resins, polyether resins, etc., are exemplified. These resins may be used by one kind alone, or two or more kinds of resins may be used in combination. The amount of these covering resins is preferably from 0.1 to 10 weight parts or so to the carrier, and more preferably from 0.5 to 3.0 weight parts.

In the manufacture of the carriers, a heating type kneader, a heating type Henschel mixer, and a UM mixer can be used, and a heating type fluidized rolling bed and a heating type kiln can be used according to the amount of the covering resins.

The blending ratio of the electrostatic-image-developing toner and the carrier in the electrostatic image developer is not especially restricted and optionally selected according to the use purpose.

### (Image-Forming Method)

The electrostatic charge developer (electrostatic charge developing toner) can be used in image-forming methods of ordinary electrostatic charge developing systems (electrophotographic systems).

Specifically, the image-forming method according to an aspect of the invention includes a latent image-forming process of forming an electrostatic latent image on the surface of a latent image carrier, a developing process of developing the electrostatic latent image formed on the surface of the latent image carrier with a developer containing a toner to form a toner image, a transfer process of transferring the toner image formed on the surface of the latent image carrier to the surface of an object to be transferred, and a fixing process of fixing the toner image transferred to the surface of the object to be transferred. The image-forming method may contain a cleaning process, if necessary.

Each of the above processes is ordinary process in itself and is disclosed, e.g., in JP-A-56-40868 and JP-A-49-91231. The image-forming method according to an aspect of the invention can be carried out with well-known image-forming apparatus such as copiers and facsimile equipments.

The latent image-forming process is a process of forming an electrostatic latent image on the surface of a latent image carrier. The developing process is a process of forming a toner image by developing the electrostatic latent image with a developer layer on a developer carrier. The developer layer is not especially restricted so long as the layer contains the electrostatic image developer according to an aspect of the invention containing the electrostatic-image-developing toner according to an aspect of the invention. The transfer process is a process of transferring the toner image onto an object to be transferred. The cleaning process is a process of removing the electrostatic image developer remaining on the electrostatic latent image carrier. The image-forming method according to an aspect of the invention may further include a recycling process. The recycling process is a process for carrying the electrostatic-image-developing toner collected in the cleaning process to the developer layer. The image-forming method of the exemplary embodiment including the recycling process can be carried out according to image-forming apparatus of the type of a toner-recycling system, such as copiers and facsimile equipments. Further, the image-forming method can also be applied to a system of an exemplary embodiment of collecting the toner simultaneously with development by omitting the cleaning process.

### (Image-Forming Apparatus)

The image-forming apparatus according to an aspect of the invention includes an electrostatic latent image carrier, a charging unit for charging the surface of the electrostatic latent image carrier, an exposure unit for forming an electrostatic latent image on the surface of the electrostatic latent image carrier charged with the charging unit by exposure in response to image information, a developing unit for forming a toner image by developing the electrostatic latent image with a developer containing a toner, and a transfer unit for transferring the toner image from the carrier to a material to be recorded, and, if necessary, a fixing unit for fixing the toner image on a base material for fixation. In the transfer unit, transfer may be carried out two or more times by using intermediate transfer media.

The constitutions of the electrostatic latent image carrier and each unit described in each process of the above image-forming method are preferably used.

As each unit described above, various units known in image-forming apparatus can be used. The image-forming apparatus for use in the invention may include units and equipments having the constitutions other than those described above. In the image-forming apparatus in the invention, two or more units described above may be used at the same time.

### EXAMPLE

The invention will be described in detail below with reference to examples, but the invention should not be construed as being restricted to these examples. In the examples “%” and “parts” mean “wt %” and “weight parts” respectively, unless otherwise indicated.

The toners in the examples are prepared as follows: Each of a resin grain dispersion, a colorant grain dispersion and a releaser grain dispersion shown below is prepared, a polymer of metal salt is added to the above dispersions in a prescribed proportion while mixing and stirring the dispersions, and the mixture is neutralized in the ionic property to form flocculated grains.

In the next place, inorganic hydroxide is added to the reaction system to adjust the pH in the system from weak acid to neutral, and then the flocculated grains are heated at a temperature not lower than the glass transition point or not lower than the melting point of the resin grains, thereby the resin grains are melted and coalesced.

After termination of the reaction, a desired toner is obtained through sufficient washing, solid-liquid separation, and drying. Each preparation method and the measuring method of each characteristic value are described below.

### <Measurement of Melting Point and Glass Transition Point>

A melting point and a glass transition point are measured with “DSC-20” (manufactured by Seiko Instruments Inc.), by heating 10 mg of a sample at a temperature of a constant raising rate (10° C./min).

In the measurement of the melting point of a crystalline resin, a differential scanning calorimeter (DSC) is used. The melting point is found as the melting peak temperature in the measurement of input compensation differential scanning calorimetry shown in JIS K-7121:87 in performing measurements from room temperature to 150° C. by a temperature rising rate of 10° C. per minute. There are cases where crystalline resins show a plurality of melting peaks, and the maximum peak is regarded as melting point in the invention.

The glass transition point of non-crystalline resins is a value obtained by measurement in conformity with the method provided in ASTM D3418-82 (a DSC method). “Crystallizability” shown in the above “crystalline polyester resins” shows to have a clear endothermic peak not stepwise endothermic variation in differential scanning calorimetry (DSC), and specifically means that the half value width of the endothermic peak measured at a temperature rising rate of 10° C. per minute is not higher than 10° C. On the other hand, resins having the half value width of endothermic peak exceeding 10° C. and resins not having a clear endothermic peak mean to be non-crystalline (amorphous).

### <Measurement of Weight Average Molecular Weight Mw and Number Average Molecular Weight Mn>

The values of weight average molecular weight Mw and number average molecular weight Mn are measured by gel permeation chromatography (GPC) on the following condition. A solvent (tetrahydrofuran) is flown at a flow rate of 1.2 ml/min at 40° C., and 3 mg of a tetrahydrofuran sample solution having concentration of 0.2 g/20 ml is poured as the sample weight and measurement is performed. Further, in measuring the molecular weight of the sample, measuring condition is selected such that the molecular weight of the sample is included in the range where the logarithms of the molecular weights of calibration curves made by several kinds of monodispersed polystyrene standard samples and the count numbers make a straight line.

Incidentally, the reliability of the result of measurement can be confirmed by the fact that NBS706 polystyrene standard sample on the above measuring condition shows the following values.

Weight average molecular weight Mw: 28.8×10⁴
Number average molecular weight Mn: 13.7×10⁴

As the columns of GPC, TSK-GEL, GMH (manufactured by TOSO CORPORATION) are used.

The solvent and measuring temperature are optionally changed according to the measuring sample.

When a resin grain dispersion is manufactured by using aliphatic polyester as the polyester and a monomer containing aromatic group as the addition polymerizable resin and the molecular weights of both resins are analyzed by GPC, respective molecular weights can be analyzed with a detector attached with an apparatus separating UV and RI.

### <Polymerization of Polyester Resin 1>

| | |
|---|---|
| 1,4-Cyclohexanedicarboxylic acid | 107.1 weight parts |
| Phthalic acid anhydride | 276.4 weight parts |
| Ethylene oxide 2 mol adduct of bisphenol A | 708.8 weight parts |
| 2,2-Dimethylolbutanoic acid | 4.9 weight parts |
| Dodecylbenzenesulfonic acid | 3.3 weight parts |

The above materials are blended and placed in a stainless steel reactor equipped with a stirrer, and subjected to polycondensation reaction under reduced pressure (20 kPa) at 130° C. for 5 hours. After 5 hours of the polymerization, the reaction system is further subjected to polycondensation for 20 hours by raising the temperature to 145° C. (the degree of pressure reduction of 5.0 kPa or less) to obtain homogeneous and transparent amorphous polyester resin 1. The weight average molecular weight of polyester resin 1 by GPC is 13,900, and the glass transition temperature (onset) is 56° C. The acid value of the polymer composition (polyester resin 1) dissolved in THF and measured with an ethanol solution of potassium hydroxide is 18 mg KOH/g.

### <Polymerization of Polyester Resin 2>

| | |
|---|---|
| 1,4-Cyclohexanedicarboxylic acid | 428.7 weight parts |
| Dodecenylsuccinic acid | 165.8 weight parts |
| Ethylene oxide 2 mol adduct off bisphenol A | 737.7 weight parts |
| Bisphenoxyethanolfluorene | 201.7 weight parts |
| 2,2-Dimethylolbutanoic acid | 5.0 weight parts |
| Dodecylbenzenesulfonic acid | 6.1 weight parts |

The above materials are blended and placed in a stainless steel reactor equipped with a stirrer, and subjected to polycondensation reaction under reduced pressure (20 kPa) at 130° C. for 5 hours. After 5 hours of the polymerization, the reaction system is further subjected to polycondensation for 20 hours by raising the temperature to 145° C. (the degree of pressure reduction of 5.0 kPa or less) to obtain homogeneous and transparent amorphous polyester resin 2. The weight average molecular weight of polyester resin 2 by GPC is 13,500, the glass transition temperature (onset) is 55° C., and the acid value of the resin is 13 mg KOH/g.

### <Preparation of Colorant Grain Dispersion (Pigment Dispersion)>

Cyan pigment (1,000 weight parts) (Pigment Blue 15:3, manufactured by Dainichiseika Color & Chemicals Mfg. Co., Ltd.), 150 weight parts of an anionic surfactant (Neogen R, manufactured by DAI-ICHI KOGYO SEIYAKU CO., LTD.), and 9,000 weight parts of ion exchange water are blended, dissolved, and dispersed for about 1 hour with a high pressure impact disperser Altimizer (Model HJP30006, manufactured by Sugino Machine Limited) to prepare a cyan pigment dispersion (a colorant grain dispersion). The average grain size of the dispersed cyan pigment is 0.15 μm, and the colorant grain concentration is 23 wt %.

### <Preparation of Releaser Grain Dispersion (Ester Wax Dispersion)>

Ester wax (50 weight parts) (WE-2, melting point: 65° C., manufactured by Nippon Oils & Fats Co., Ltd.), 5 weight parts of an anionic surfactant (Neogen RK, manufactured by DAI-ICHI KOGYO SEIYAKU CO., LTD.), and 200 weight parts of ion exchange water are heated at 95° C., dispersed with a homogenizer (ULTRA-TURRAX T50, manufactured by IKA® Japan), and then subjected to dispersion treatment with a Manton Gaulin high pressure homogenizer (manufactured by Gaulin Co., Ltd.) to prepare a releaser grain dispersion (an ester wax dispersion) having an average grain size of 0.23 μm and grain concentration of 20 wt %.

### Example 1

### Preparation of Resin Grain Dispersion

After dissolving 3 weight parts of 2,2,6,6-tetramethyl-piperine-1-oxy (TEMPO) in 60 weight parts of a vinyl monomer mixture (mixing ratio: styrene (62.5 weight parts)/n-butyl acrylate (11.0 weight parts)/dodecanethiol (0.8 weight parts)/acrylic acid (3.6 weight parts)), the solution is added to 200 weight parts of polyester resin 1 and thoroughly stirred and blended at 120° C.

After that, 14 weight parts of triethanolamine is added to the mixture to neutralize the carboxylic acid in the polyester resin. Sodium dodecylbenzenesulfonate (6 weight parts) is added to the above mixture, and stirring is continued for further 1 hour at 120° C. After the temperature is lowered to 100° C., 600 weight parts of boiling water at 95° C. is dropped to the above neutralized resin mixture with stirring the resin to obtain resin grain dispersion 1. The grain size of the emulsified product on measurement with a light scattering grain size distribution measuring apparatus (LA920, manufactured by Horiba, Ltd.) is 250 nm.

After 10 weight parts of ascorbic acid is further added to the emulsified product, 3 weight parts of distilled water containing 1.2 weight parts of ammonium persulfate dissolved is added thereto, and polymerization of the vinyl monomer is carried out under nitrogen current at 80° C. for 5 hours to obtain resin grain dispersion 2. The monomer polymerization rate of the obtained polymerized product by weight-dry method is 99.99%, the grain size is 180 nm, the weight average molecular weight is 14,500, Tg is 54° C., and the solid content is 33.2%.

Here, the rate of polymerization by weight-dry method is measured in conformity with JIS K₆₃₈₇-2. Specifically, all the solids content of the obtained resin is measured, and the rate of polymerization is found from the ratio of the solids content computed from the case where all the amounts of the used monomers are polymerized to the solids content actually measured.

### <Preparation of Toner Grains 1: Emulsification Polymerization Flocculation Method>

Resin grain dispersion 2 (275 weight parts) obtained by polymerization of the radically polymerizable monomer, 34.4 weight parts of the above colorant grain dispersion (pigment dispersion), 33 weight parts of the releaser grain dispersion (ester wax dispersion), 573 weight parts of ion exchange water, and 1.8 weight parts of sodium alkyl biphenyl ether disulfonate are put in a cylindrical stainless reactor, and the mixture is dispersed and blended with ULTRA-TURRAX while applying shear force at 8,000 rpm for 15 minutes. Subsequently, 0.18 weight parts of a 10% nitric acid aqueous solution containing polyaluminum chloride is dropped thereto as the flocculating agent. At this time, pH of the dispersion is adjusted to the range of 2.8 to 3.2 with a 0.1N sodium hydroxide aqueous solution and a 0.1N nitric acid aqueous solution.

After that, the resin grains, colorant grains and releaser grains are gradually flocculated by heating in a stainless steel kettle equipped with a stirrer and a thermometer while stirring the raw material dispersion, and the volume average grain size is adjusted to 6.0 μm (measured with TA-II, manufactured by Coulter Counter, aperture diameter: 50 μm). The pH of the reaction system is raised to 9.0 and the temperature is increased to 95° C. and the temperature is retained for 3 hours to obtain potato-like shaped toner grains having a volume average grain size of 6.0 μm and a volume average grain size distribution index (GSDᵥ) of 1.25. Subsequently, the obtained toner grains are cooled, sieved through a filter having a mesh size of 45 μm, sufficiently washed with water repeatedly, and then dried with a refrigerating drier to obtain toner grains 1.

The volume average grain size and volume average grain size distribution index (GSDᵥ) are measured with measuring equipment of a Coulter Counter TAII (manufactured by Beckman Coulter K.K.). The cumulative distribution of the volume of grains is drawn from the smaller grain side to the grain size range (channel) divided based on the grain size distribution measured, and the grain size of accumulation of 16% is defined as volume D₁₆ᵥ, the grain size of accumulation of 50% is defined as volume D₅₀ᵥ, and the grain size of accumulation of 84% is defined as volume D₈₄ᵥ. By using these values, a volume average grain size distribution index (GSDᵥ) is computed as (D₈₄ᵥ/D₁₆ᵥ)^{1/2}.

Incidentally in the invention, the volume average grain size means the above-explained D₅₀ᵥ.

### <Preparation and Evaluation of Electrostatic Image Developer 1>

One part of colloidal silica (R972, manufactured by Nippon Aerosil Co., Ltd.) is externally added to 100 parts of toner grains 1 and blended with a Henschel mixer to obtain an electrostatic-image-developing toner.

One hundred (100) parts of ferrite grains (average grain size: 50 μm, manufactured by Powder Tech Co., Ltd.) and 1 part of a polymethyl methacrylate resin (the molecular weight: 95,000, manufactured by Mitsubishi Rayon Co., Ltd.) are put in a pressure kneader with 500 parts of toluene, blended at ordinary temperature for 15 minutes, the temperature is raised to 70° C. under reduced pressure while blending to distill off the toluene, and then the reaction system is cooled and graded through a sieve having a mesh size of 105 μm to prepare a ferrite carrier (resin-covered carrier).

The ferrite carrier and the above electrostatic-image-developing toner are blended to manufacture a two-component system electrostatic image developer having toner concentration of 7 wt %.

Using the electrostatic image developer, a fixing property and image quality characteristics are evaluated as follows. The results obtained are shown in Table 1 below.

### —Fixing Property and Image Quality Characteristics—

A fixing property and image quality characteristics are evaluated as follows. An image is formed with modified Docu Centre Color 500CP (manufactured by Fuji Xerox Co., Ltd.), and the fixing temperature and the image quality of initial image are evaluated. As the evaluation items, regarding the fixing property, whether fixation free from offset (fixing failure) at a fixing temperature of 130° C. is possible or not is evaluated, and the fixed image strength is measured by pencil hardness (UNI, hardness: H, manufactured by Mitsubishi Pencil Co., Ltd.). As to the image quality characteristics, uniformity (unevenness) in image quality by fixation at 150° C. is evaluated by visual observation.

The criteria of evaluation of fixing property are as shown below.

A: Free from offset, having excellent image strength and practicably excellent in fixing property.
B: Free from offset, offering no problem in image strength, and practicably no problem in fixation.
C: Offset is slightly observed, and problematic in practicability.
F: Failure in fixation due to offset and impracticable.

On the other hand, the criteria of evaluation of image quality characteristics are as follows.

A: Showing sufficient image strength and excellent uniformity in image quality, and practicably excellent.
B: Practicable in image strength and uniformity in image quality.
C: Image strength is sufficient, but unevenness in image quality is slightly observed, and problematic in practicability.
F: Image strength and uniformity in image quality are not sufficient and impracticable.

The results obtained are shown in Table 1.

### Example 2

After dissolving 3 weight parts of 4-hydroxy-2,2,6,6-tetramethylpiperine-1-oxy (Hydroxy TEMPO) in 20 weight parts of a vinyl monomer mixture (mixing ratio: styrene (62.5 weight parts)/n-butyl acrylate (11.0 weight parts)/dodecanethiol (0.8 weight parts)/acrylic acid (3.6 weight parts)), the solution is added to 200 weight parts of polyester resin 2 and thoroughly stirred and blended at 120° C.

After that, 10 weight parts of triethanolamine is added to the mixture to neutralize the carboxylic acid in the polyester resin. Sodium dodecylbenzenesulfonate (2 weight parts) is added to the above mixture, and stirring is continued for further 1 hour at 120° C. After the temperature is lowered to 100° C., 580 weight parts of boiling water at 95° C. is dropped to the above neutralized resin mixture with stirring the resin to obtain resin grain dispersion 3. The grain size of the emulsified product on measurement with a light scattering grain size distribution measuring apparatus (LA920, manufactured by Horiba, Ltd.) is 180 nm.

After 10 weight parts of ascorbic acid is further added to the emulsified product, 3 weight parts of distilled water containing 1.2 weight parts of ammonium persulfate dissolved is added thereto, and polymerization of the vinyl monomer is carried out under nitrogen current at 80° C. for 5 hours to obtain resin grain dispersion 4.

The monomer polymerization rate of the obtained polymerized product by weight-dry method is 99.99%, the grain size is 240 nm, the weight average molecular weight is 18,000, Tg is 59° C., and the solid content is 29.7%.

### <Preparation of Toner Grains 2: Emulsification Polymerization Flocculation Method>

Resin grain dispersion 4 (275 weight parts) obtained by polymerization of the radically polymerizable monomer, 34.4 weight parts of the above colorant grain dispersion (pigment dispersion), 33 weight parts of the releaser grain dispersion (ester wax dispersion), 573 weight parts of ion exchange water, and 1.8 weight parts of sodium alkyl biphenyl ether disulfonate are put in a cylindrical stainless reactor, and the mixture is dispersed and blended with ULTRA-TURRAX while applying shear force at 8,000 rpm for 15 minutes. Subsequently, 0.18 weight parts of a 10% nitric acid aqueous solution containing polyaluminum chloride is dropped thereto as the flocculating agent. At this time, pH of the raw material dispersion is adjusted to the range of 2.8 to 3.2 with a 0.1N sodium hydroxide aqueous solution and a 0.1N nitric acid aqueous solution.

After that, the resin grains, colorant grains (pigment) and releaser (wax) grains are gradually flocculated by heating in a stainless steel kettle equipped with a stirrer and a thermometer while stirring the raw material dispersion, and the volume average grain size is adjusted to 6.0 μm (measured with TA-II, manufactured by Coulter Counter, aperture diameter: 50 μm). The pH of the reaction system is raised to 9.0 and the temperature is increased to 95° C. and the temperature is retained for 3 hours to obtain potato-like shaped toner grains having a volume average grain size of 5.8 μm and a volume average grain size distribution index (GSDᵥ) of 1.23. Subsequently, the obtained toner grains are cooled, sieved through a filter having a mesh size of 45 μm, sufficiently washed with water repeatedly, and then dried with a refrigerating drier to obtain toner grains 2.

### <Preparation and Evaluation of Developer 2>

One part of colloidal silica (R972, manufactured by Nippon Aerosil Co., Ltd.) is externally added to 100 parts of toner grains 2, and toner grains 2 are further blended with the carrier in the same manner as in Example 1 to manufacture a two-component system electrostatic image developer 2.

Using the electrostatic image developer, a fixing property and image quality characteristics are evaluated in the same manner as in Example 1.

The results obtained are shown in Table 1.

### Example 3

Resin grain dispersion 5 is obtained in the same manner as in Example 1 except for using 200 weight parts of resin 1, and changing the amount of the vinyl monomer mixture to 200 weight parts, TEMPO to 9 weight parts, triethanolamine to 13.5 weight parts, sodium dodecylbenzenesulfonate to 4 weight parts, and water to be added to 970 weight parts.

Further, 30 weight parts of ascorbic acid and 4 weight parts of ammonium persulfate are added thereto, and polymerization of the vinyl monomer is performed to obtain resin grain dispersion 6. The monomer polymerization rate of the obtained polymerized product by weight-dry method is 99.99%, the grain size is 220 nm, the weight average molecular weight is 32,000, Tg is 59° C., and the solid content is 32.2%.

### <Preparation of Toner Grains 3: Emulsification Polymerization Flocculation Method>

The same procedure as in Example 1 is repeated by using 275 weight parts of resin grain dispersion 6 obtained by polymerization of the radically polymerizable monomer, 34.4 weight parts of the above colorant grain dispersion (pigment dispersion), 33 weight parts of the releaser grain dispersion (ester wax dispersion), and 573 weight parts of ion exchange water to obtain potato-like shaped toner grains having a volume average grain size of 6.2 μm and a volume average grain size distribution index (GSDᵥ) of 1.22. Subsequently, the obtained toner grains are cooled, sieved through a filter having a mesh size of 45 μm, sufficiently washed with water repeatedly, and then dried with a refrigerating drier to obtain toner grains 3.

### <Preparation and Evaluation of Developer 3>

One part of colloidal silica (R972, manufactured by Nippon Aerosil Co., Ltd.) is externally added to 100 parts of toner grains 3, and toner grains 3 are further blended with the carrier in the same manner as in Example 1 to manufacture a two-component system electrostatic image developer 3.

Using the electrostatic image developer, a fixing property and image quality characteristics are evaluated in the same manner as in Example 1.

The results obtained are shown in Table 1.

### Example 4

Resin grain dispersion 7 is obtained in the same manner as in Example 1 except for using 200 weight parts of resin 2, and changing the amount of the vinyl monomer mixture to 12 weight parts, Hydroxy TEMPO to 0.5 weight parts, triethanol-amine to 10.5 weight parts, sodium dodecylbenzenesulfonate to 2 weight parts, and water to be added to 524 weight parts.

Further, 0.24 weight parts of ammonium persulfate is added thereto, and polymerization of the vinyl monomer is performed at 100° C. for 3 hours, and further 0.24 weight parts of ammonium persulfate is added and polymerization is continued at 100° C. for 3 hours to obtain resin grain dispersion 8. The monomer polymerization rate of the obtained polymerized product by weight-dry method is 99.99%, the grain size is 210 nm, the weight average molecular weight is 25,000, Tg is 55° C., and the solid content is 30.2%.

### <Preparation of Toner Grains 4: Emulsification Polymerization Flocculation Method>

The same procedure as in Example 1 is repeated by using 275 weight parts of resin grain dispersion 8 obtained by polymerization of the radically polymerizable monomer, 34.4 weight parts of the above colorant grain dispersion (pigment dispersion), 33 weight parts of the releaser grain dispersion (ester wax dispersion), and 573 weight parts of ion exchange water to obtain potato-like shaped toner grains having a volume average grain size of 5.5 μm and a volume average grain size distribution index (GSDᵥ) of 1.26. Subsequently, the obtained toner grains are cooled, sieved through a filter having a mesh size of 45 μm, sufficiently washed with water repeatedly, and then dried with a refrigerating drier to obtain toner grains 4.

### <Preparation and Evaluation of Developer 4>

One part of colloidal silica (R972, manufactured by Nippon Aerosil Co., Ltd.) is externally added to 100 parts of toner grains 4, and toner grains 4 are further blended with the carrier in the same manner as in Example 1 to manufacture a two-component system electrostatic image developer 4.

Using the electrostatic image developer, a fixing property and image quality characteristics are evaluated in the same manner as in Example 1.

The results obtained are shown in Table 1.

### Comparative Example 1

By using resin 1, resin grain dispersion 9 is obtained in the same manner as in Example 3 except for adding TEMPO. Further, polymerization of the vinyl monomer is performed in the same manner as in Example 1 by adding 4 weight parts of ammonium persulfate to obtain resin grain dispersion 10. The monomer polymerization rate of the obtained polymerized product by weight-dry method is 99.99%, the grain size is 210 nm, the weight average molecular weight is 28,000, Tg is 56° C., and the solid content is 30.3%.

### <Preparation of Toner Grains 5: Emulsification Polymerization Flocculation Method>

The same procedure as in Example 1 is repeated by using 275 weight parts of resin grain dispersion 10 obtained by polymerization of the radically polymerizable monomer, 34.4 weight parts of the above colorant grain dispersion (pigment dispersion), 33 weight parts of the releaser grain dispersion (ester wax dispersion), and 573 weight parts of ion exchange water to obtain potato-like shaped toner grains having a volume average grain size of 5.8 μm and a volume average grain size distribution index (GSDᵥ) of 1.29. Subsequently, the obtained toner grains are cooled, sieved through a filter having a mesh size of 45 μm, sufficiently washed with water repeatedly, and then dried with a refrigerating drier to obtain toner grains 5.

### <Preparation and Evaluation of Developer 5>

One part of colloidal silica (R972, manufactured by Nippon Aerosil Co., Ltd.) is externally added to 100 parts of toner grains 5, and toner grains 5 are further blended with the carrier in the same manner as in Example 1 to manufacture a two-component system electrostatic image developer 5.

Using the electrostatic image developer, a fixing property and image quality characteristics are evaluated in the same manner as in Example 1.

The results obtained are shown in Table 1.

### Comparative Example 2

Emulsification in an aqueous medium is tried by using resin 2 in the same manner as in Example 2 except for adding Hydroxy TEMPO by dissolving resin 2 and the vinyl monomer mixture by heating, but separation of polyester resin 2 and the vinyl polymer occurs en route by thermal polymerization of the vinyl monomer, and emulsification is impossible.

TABLE 1

| | | | | | | Comparative | Comparative |
|---|---|---|---|---|---|---|---|
| | | Example 1 | Example 2 | Example 3 | Example 4 | Example 1 | Example 2 |
| Resin | Polyester resin | Resin 1 | Resin 2 | Resin 1 | Resin 2 | Resin 1 | Resin 2 |
| structure | | (200 weight parts) | (200 weight parts) | (200 weight parts) | (200 weight parts) | (200 weight parts) | (200 weight |
| | | | | | | | parts) |
| | Vinyl monomer | St/BA/DDT/AA | St/BA/DDT/AA | St/BA/DDT/AA | St/BA/DDT/AA | St/BA/DDT/AA | St/BA/ |
| | mixture¹⁾ | (62.5/11.0/ | (62.5/11.0/ | (62.5/11.0/ | (62.5/11.0/ | (62.5/11.0/ | DDT/AA |
| | | 0.8/3.6) | 0.8/3.6) | 0.8/3.6) | 0.8/3.6) | 0.8/3.6) | (62.5/11.0/ |
| | | (60 weight parts) | (20 weight parts) | (200 weight parts) | (12 weight parts) | (200 weight parts) | 0.8/3.6) |
| | | | | | | | (20 weight |
| | | | | | | | parts) |
| | Nitroxide compound | TEMPO | Hydroxy TEMPO | TEMPO | Hydroxy TEMPO | — | — |
| | | (30 weight parts) | (3 weight parts) | (9 weight parts) | (0.5 weight parts) | | |
| | Weight ratio of resin | 76.9/23.1 | 90.9/9.1 | 50/50 | 94.3/5.7 | 50/50 | 90.9/9.1 |
| | (PES/V)²⁾ | | | | | | |
| | Addition amount | 22.8 | 9.0 | 49.5 | 5.6 | 49.5 | 9.0 |
| | of vinyl monomer | | | | | | |
| | (wt % in the resin) | | | | | | |
| | Addition of acid | Ascorbic acid | Ascorbic acid | Ascorbic acid | — | — | — |
| | | (10 weight parts) | (10 weight parts) | (30 weight parts) | | | |
| Resin grain | Grain size | 180 | 240 | 220 | 210 | 210 | The resin |
| dispersion | Weight average | 14,500 | 18,000 | 32,000 | 25,000 | 28,000 | cannot be |
| | molecular weight | | | | | | emulsified. |
| | Tg (° C.) | 54 | 59 | 59 | 55 | 56 | |
| | Solid content (%) | 33.2 | 29.7 | 32.2 | 30.2 | 30.3 | |
| Characteristics | Toner grain size (μm) | 6.0 | 5.8 | 6.2 | 5.5 | 5.8 | The resin |
| of toner | GSDᵥ | 1.25 | 1.23 | 1.22 | 1.26 | 1.29 | cannot be |
| | Fixing property | A | A | B | B | F | emulsified. |
| | (130° C.) | | | | | | |
| | Image quality | B | A | B | A | C | |
| | characteristics | | | | | | |
| | (150° C.) | | | | | | |

¹⁾St: styrene, BA: n-butyl acrylate, DDT: dodecanethiol, AA: acrylic acid
²⁾PES/V: weight ratio (mixture of polyester resin/vinyl monomer)

What is claimed is:

1. A resin for an electrostatic-image-developing toner comprising:
a polyester resin;
a vinyl polymer resin obtained by polymerization of a radically polymerizable vinyl monomer; and
at least one of a nitroxide compound and a reaction product of a nitroxide compound and an acid.

2. The resin for an electrostatic-image-developing toner according to claim 1, wherein
the polyester resin has a weight average molecular weight of from about 1,500 to about 60,000.

3. The resin for an electrostatic-image-developing toner according to claim 1, wherein
the polyester resin has an acid value of about from 3 mg KOH/g to about 50 mg KOH/g.

4. The resin for an electrostatic-image-developing toner according to claim 1, wherein
the nitroxide compound comprises at least one of 2,2,6,6-tetramethylpiperidine-1-oxy (TEMPO) and 4-hydroxy-2,2,6,6-tetramethylpiperine-1-oxy (Hydroxy TEMPO).

5. The resin for an electrostatic-image-developing toner according to claim 4, wherein
the nitroxide compound is contained in an amount of about from 0.01 wt % to about 20 wt % based on all amount of the racially polymerizable vinyl monomer and the polyester resin

6. The resin for an electrostatic-image-developing toner according to claim 1, wherein
the radically polymerizable vinyl monomer comprises a styrene.

7. The resin for an electrostatic-image-developing toner according to claim 1, wherein
the vinyl polymer resin is contained in an amount of from about 5 wt % to about 50 wt % in all the resins.

8. The resin for an electrostatic-image-developing toner according to claim 1, wherein
the radically polymerizable vinyl monomer comprises at least one of a styrene and a styrene derivative.

9. The resin for an electrostatic-image-developing toner according to claim 8, wherein
the at least one of a styrene and a styrene derivative is contained in an amount of about 50 wt % or more in all the radically polymerizable vinyl monomer.

10. An electrostatic-image-developing toner comprising:
the resin for an electrostatic-image-developing toner according to claim 1.

11. The electrostatic-image-developing toner according to claim 10, wherein
the polyester resin has a weight average molecular weight of from about 1,500 to about 60,000.

12. The electrostatic-image-developing toner according to claim 10, wherein
the polyester resin has an acid value of about from 3 mg KOH/g to about 50 mg KOH/g.

13. The electrostatic-image-developing toner according to claim 10, having a cumulative volume average grain size D₅₀ᵥ of from about 3.0 μm to about 9.0 μm.

14. The electrostatic-image-developing toner according to claim 10, having a volume average grain size distribution index GSDᵥ of about 1.30 or less.

15. The electrostatic-image-developing toner according to claim 10, having a shape factor SF1 of from about 100 to about 140.

16. An electrostatic image developer comprising:
the electrostatic-image-developing toner according to claim 10; and
a carrier.

17. A method for forming an image, the method comprising:
forming an electrostatic latent image on a surface of a latent image carrier;
developing the formed electrostatic latent image with the electrostatic image developer according to claim 16 to form a toner image;
transferring the formed toner image to a surface of an object; and
fixing the transferred toner image.

18. An image-forming apparatus comprising:
a latent image carrier;
a charging unit that charges the latent image carrier;
an exposure unit that exposes the charged latent image carrier to form an electrostatic latent image on the latent image carrier;
a developing that develops the electrostatic latent image with the electrostatic image developer according to claim 16 to form a toner image; and
a transfer unit that transfers the formed toner image from the latent image carrier to a material to be recorded.
